(19) United States
(12) Patent Application Publication
(10) Pub. No.: US 2025/0214143 A1
(43) Pub. Date: Jul. 3, 2025

(54) JETTING PERFORMANCE OF MOLTEN METAL ALLOYS BY CONTROLLING THE CONCENTRATION OF KEY ALLOYING ELEMENTS

(71) Applicant: Desktop Metal, Inc., Burlington, MA (US)

(72) Inventors: Uwe BAUER, Cambridge, MA (US); Mark GIBSON, Carlisle, MA (US); Emanuel SACHS, Newton, MA (US); Robert BARBATI, Cambridge, MA (US); Alexander BARBATI, Cambridge, MA (US); Brian KERNAN, Andover, MA (US)

(21) Appl. No.: 19/084,800

(22) Filed: Mar. 20, 2025

Related U.S. Application Data
(63) Continuation of application No. 17/670,395, filed on Feb. 11, 2022, now abandoned.
(60) Provisional application No. 63/149,185, filed on Feb. 12, 2021.

(51) Int. Cl. B22F 10/22; B22D 23/00; B22F 12/53; B33Y 10/00; B33Y 30/00; B33Y 70/00; C22C 21/06

(52) U.S. Cl. CPC B22F 10/22; B22D 23/003; B22F 12/53; B33Y 10/00; B33Y 30/00; B33Y 70/00; C22C 21/06

(57) ABSTRACT

A method for improving part quality in additive manufacturing involving jetting liquid metal. Limiting the amounts of magnesium and zinc in a meniscus material to below predetermined thresholds improves jetting quality. Further, ensuring an amount of Strontium is above a predetermined threshold further improves jetting of the liquid metal.

### RELATED APPLICATIONS

This application is a continuation of U.S. patent application Ser. No. 17/670,395, filed Feb. 11, 2022 which claims priority to U.S. Provisional Application U.S. 63/149,185, filed Feb. 12, 2021. The contents of the above-mentioned applications are incorporated herein by reference.

### BACKGROUND/SUMMARY

### Technical Field

The present application relates to improving jetting performance of liquid metal alloys during additive manufacturing.

### Background of the Disclosure

There are certain apparatuses for the additive manufacture of metal articles by the deposition of droplets of liquid metal. An example of such a system is the magnetohydrodynamic (MHD) jetting system disclosed by U.S. Pat. No. 10,201,854, entitled “Magnetohydrodynamic Deposition of Metal In Manufacturing” and filed Mar. 6, 2017, the contents of which are incorporated by reference herein in their entirety. This system includes a nozzle containing liquid metal. The liquid metal is subject to a magnetic field in a first axis. When jetting is desired, current is passed through the liquid metal in a second axis perpendicular to the first axis such that a Lorenz force is produced in the liquid metal, by which a droplet of liquid metal is ejected from a meniscus formed on an opening of the nozzle. There are other metal drop-on-demand additive manufacturing systems and a variety of metals that may be jetted as liquids. The contents of the present application will be applicable to those systems and metals in addition to MHD jetting.

In metal drop-on-demand printing, a high-quality droplet jet is a prerequisite for printing high quality metal parts. A high-quality droplet jet is made up of droplets with well-defined characteristics such as size, velocity and trajectory (i.e. jetting angle) and is able to maintain these droplet characteristics within a tight range over long periods of time. These droplet characteristics, however, are very sensitive to jetting conditions at the meniscus and in practice are often prone to large variations over time. These variations in droplet characteristics can be mitigated to some degree by frequent nozzle maintenance, for instance by regularly nozzle cleaning. Such nozzle maintenance steps, however, exhibit limited effectiveness and are often unreliable, time consuming (i.e., reduce the build rate of the printer) and technically complex to implement.

Similar problems exist when a continuous stream of molten metal is jetted from the nozzle. In order to achieve a high-quality continuous stream, it is important to maintain characteristics such as for instance the stream trajectory, the stream diameter and the flow rate of the stream within a well-controlled range over time. In MHD jetting, for instance, such a continuous stream of molten metal can be jetted from the nozzle by passing of a DC current though the molten metal. While the preceding and following discussion are framed in terms of droplet jetting, it should be understood that the disclosure related to droplet jetting applies similarly to continuous stream jetting.

It is believed that one of the main factors influencing the droplet and continuous stream characteristics discussed above, can be found in the configuration of the molten metal meniscus in/on the jetting nozzle. The build-up of dross, such as oxide, on the nozzle and/or the molten metal, as well as variations in the interaction between the molten metal and the nozzle and/or the molten metal and the dross, such as for instance their wetting interaction, can dramatically change the configuration of the molten metal meniscus and thus the characteristics of the droplet and continuous stream jet. Nozzle maintenance steps, such as the nozzle cleaning and wiping steps, can mitigate some of these issues by, for instance, breaking-up or removing the dross or by spreading the molten metal back over areas of the nozzle that might have de-wetted. The effect of these maintenance steps is however temporary in nature and frequent repetition is needed for lasting improvements in jet quality.

It is believed that another possible factor influencing the droplet and continuous stream characteristics, can be found in the configuration of the molten metal inside the nozzle such as for instance inside the throat of the nozzle. For instance, poor wetting between the molten metal and internal faces of the nozzle may result in gas ingestion, gas pockets and excessive oxide formation during jetting, which can change the response of the MHD system to a given jetting force and thus undesirably modify the droplet and stream characteristics.

### SUMMARY OF THE DISCLOSURE

The present disclosure accomplishes increased jetting performance through control of the concentration of key alloying elements in the meniscus material. This provides a much more effective, reliable and convenient path to improve the jet quality in metal drop on demand printing than prior methods.

Without being bound by theory, by keeping the concentration of a highly reactive element like magnesium below a specific limit, the build-up of dross can be minimized, or by requiring a minimum level of an alloying element that promotes wetting, like Strontium, de-wetting of the molten metal from the nozzle can be prevented.

The present application relates to the composition of the meniscus material used for liquid metal jetting in metal drop-on-demand printers. It has been discovered that small quantities of specific alloying elements can have a dramatic effect on the usability and performance of the liquid metal jetting process. Specifically, carefully controlling the presence of key alloying elements such as strontium, magnesium and zinc is critical in making a meniscus material amenable to high quality jetting.

The present disclosure is directed to controlling the concentration of one or more of the alloying elements strontium, magnesium and zinc in the meniscus material for metal drop-on demand-jetting. For strontium, it is essential that a minimum amount is present in the meniscus material, whereas for magnesium and zinc it is highly desirable that no more than a maximum amount is present in the meniscus material to minimize the amount of nozzle maintenance required.

### DESCRIPTION

### Brief Description of the Drawings

FIGS. 1A-B depict a MHD jetting system.

FIGS. 2A-D depict jetting from a wetted MHD nozzle.

FIGS. 3 and 4 each depict a non-wetted MHD nozzle.

### DETAILED DESCRIPTION

The present disclosure relates to the composition of the meniscus material used for liquid metal jetting in metal drop on demand printers. Small quantities of specific alloying elements can have a dramatic effect on the usability and performance of such meniscus materials in the liquid metal jetting process. Specifically, carefully controlling the presence of key alloying elements such as strontium, magnesium and zinc is important in making a meniscus material amenable to high quality jetting. While the following discussion focuses on aluminum-silicon alloys, the benefit of controlling the strontium, magnesium and zinc level is not limited to aluminum-silicon alloys but applies more broadly to other aluminum alloys and other metals. The applicable concentration ranges and possible working mechanisms of the key alloying elements strontium, magnesium and zinc found useful in aluminum-silicon alloys for MHD jetting are discussed in detail below.

For the implementation of this disclosure, it is important to distinguish between the terms “feedstock material”, “build material”, “meniscus material” and “throat material”, which describe the material processed by the MHD printer during an MHD printing process. Within this paragraph, the term “material” without a preceding descriptor (ex., “feedstock”) refers to materials intended for processing, i.e., excluding unintended materials such as for instance build-up or contaminants (ex. oxides). Here, the term “feedstock material” refers to the material(s) that is supplied to the jetting nozzle. The term “build material” refers to the material jetted from the nozzle that forms the part. The term “meniscus material” is any material that is present in or contained by or in the immediate vicinity of a meniscus formed at a face or faces of a jetting nozzle, including the volume of material interfacing with the nozzle face. The meniscus material may be in some, but not all, applications the same as the build material. So, if there are multiple feedstock materials, the meniscus material is usually the product that results from the combination of the feedstock materials in the nozzle along with any additional materials intentionally introduced or produced at the jetting orifice or nozzle face. The meniscus material also includes any materials intentionally introduced to or produced in the meniscus in addition to the feedstock materials. The term “throat material” refers to any portion of the material that is present in the throat of the jetting nozzle and any material in the vicinity of an inlet of the throat of the jetting nozzle. In certain instances, control of the throat material, in the same way as described herein for the meniscus material may provide beneficial effects.

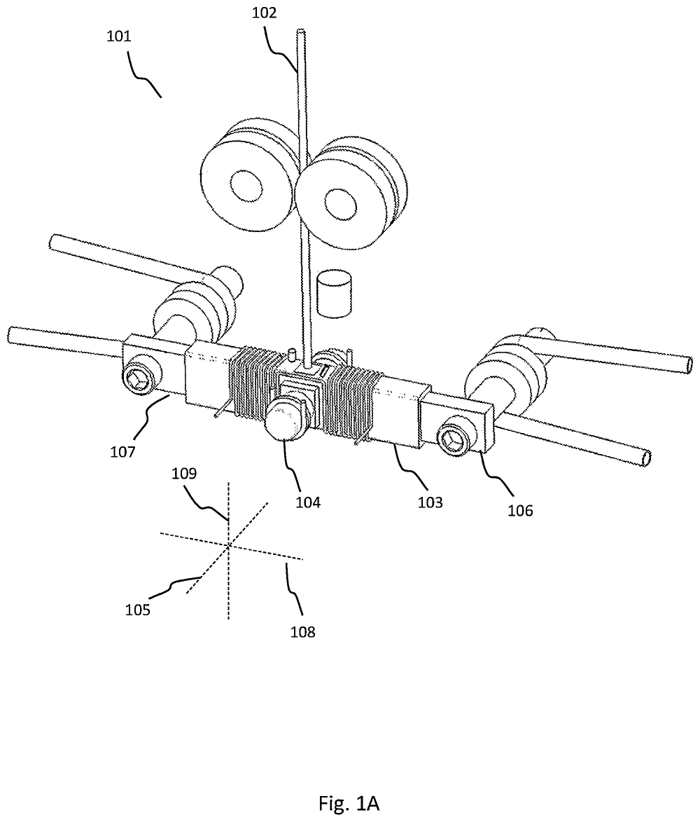

FIG. 1A depicts a MHD jetting system 101. Feedstock 102 is fed into a nozzle 103. A magnet system 104 produces a magnetic field along axis 105. When jetting is desired, electrical current is passed from a first electrode 106 through the liquified metal in the nozzle 103 and to a second electrode 107, providing a flow of electrical current along an axis 108. This creates a jetting force in axis 109. FIG. 1B depicts a droplet 110 being ejected from a nozzle orifice 111.

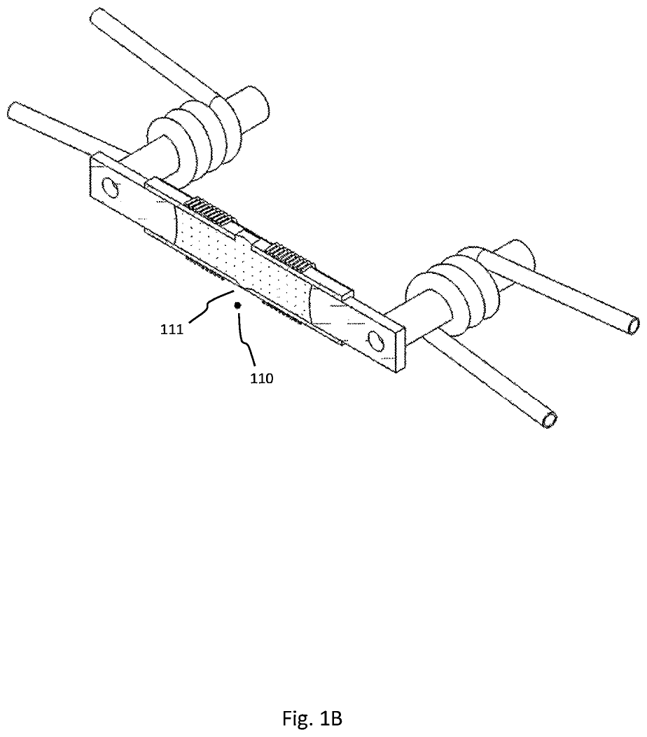

FIG. 2A depicts a wetted nozzle 201 that includes a throat 202 and stem face 203. Liquid metal 204 flows through the throat 202 and forms a meniscus 205 wetted to stem face 203. FIG. 2B depicts the meniscus as a jetting force is applied, forming a droplet 206 still attached to the stem face 203. In FIG. 2C, the droplet 206 has separated from the nozzle 201. In FIG. 2D, the droplet 206 is flying toward a build area.

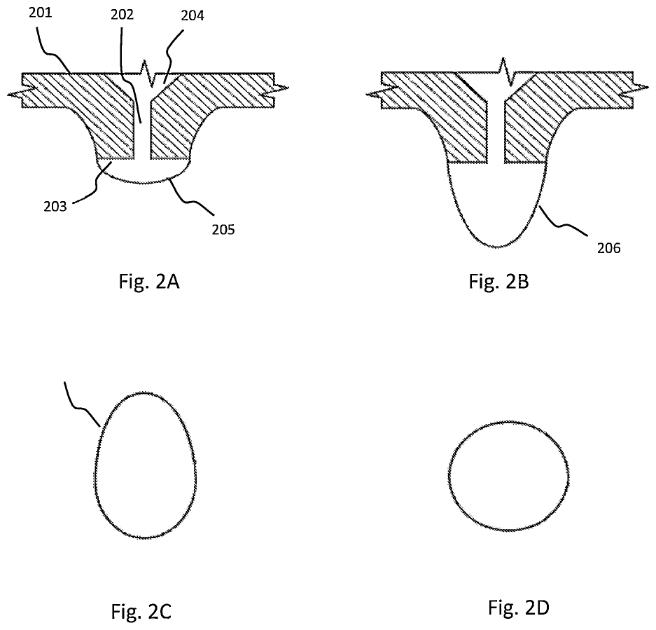

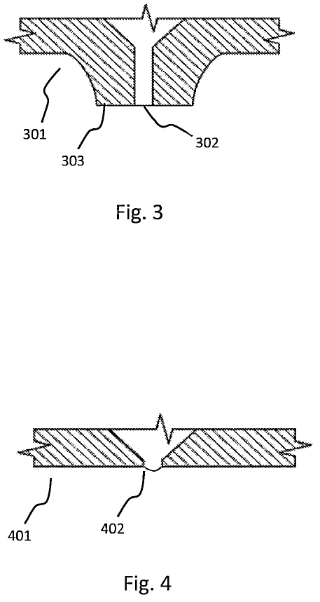

FIG. 3 depicts a non-wetted nozzle 301 in which a meniscus 302 does not wet to a outer stem face 303. FIG. 4 depicts a non-wetted nozzle 401 with a meniscus 402 formed at an ejection orifice that is surrounded by a non-wetted surface. Because the non-wetted nozzles does not require a stem face for maintaining a meniscus the stem is omitted.

In order to implement the subject matter of the present disclosure, it is critical that the specified alloying elements are present within their specified concentration ranges in the meniscus material. The most direct way of achieving the desired alloy composition in the meniscus material, is to use a single feedstock material and control the composition of this feedstock material. Typically, such a feedstock material would be supplied in wire form, so it is practical to make a wire of feedstock material with a custom composition, containing some or all of the key alloying elements described here, in their specified concentrations. Alternatively, this custom feedstock material may also be supplied in other forms, such as for instance as rods, ingots, powders or granules.

A minimum level of strontium is required for aluminum-silicon alloys to be usefully employed as meniscus materials in the metal drop-on-demand jetting process. When strontium is present in the meniscus material at a concentration of at least 10 ppmw, or better of at least 50 ppmw or even better of at least 100 ppmw the jetting quality increases significantly. In the absence of such a minimum level of strontium in the meniscus material, the quality of the molten metal droplet jet deteriorates rapidly, often within just a few minutes of jetting droplets. For aluminum-silicon alloys such as for instance A356 aluminum, the addition of such a minimum amount of strontium significantly improves the jetting performance from an alumina nozzle.

Aluminum welding wire may be used as a source of feedstock material for metal drop-on-demand printing. The composition of aluminum welding wire is typically highly specified, but there is no specification specific to strontium (other than general maximum concentrations for “other” alloying elements).

From compositional analysis of samples of aluminum welding wire, it has been found that this welding wire often contains a small amount of strontium, but the strontium concentration can vary widely between batches of nominally the same welding wire alloy. The presence of strontium in the welding wire is likely due to the use of recycled aluminum as an input material in the wire making process. Strontium is a modifier that is commonly used in the aluminum casting industry to improve the mechanical properties of castings. When such castings are recycled and randomly end up as input material in the welding wire, they result in the random strontium concentration observed in the analyzed aluminum welding wire.

By virtue of its application in the aluminum casting industry, strontium is a known and used alloying element and its addition to the build material therefore represents little risk to the function and properties of the material and printed parts. Thus the use of strontium over other potential alloying elements has the advantage that when the final parts contain the strontium they may still be considered and accepted as being according to common standards.

Thus, only by requiring that the meniscus material contains a minimum amount of strontium does it become useful for high quality jetting.

Without being bound by theory, one likely explanation for the loss in jetting quality is the absence of a sufficiently high strontium concentration, is that the molten meniscus material has a tendency to de-wet from the nozzle during jetting. This de-wetting effect destabilizes the droplet jet and renders the material unusable for high quality drop-on-demand jetting. Similarly, the absence of a sufficiently high strontium concentration in the throat material, is believed to result in a tendency of the molten throat material to de-wet from the nozzle. Such de-wetting may result in gas ingestion, gas pockets and excessive oxide formation inside the nozzle, which can change the response of the MHD system to a given jetting force and thus undesirably modify the droplet and stream characteristics.

Without being bound by theory, by adding the specified minimum amount of strontium to the meniscus material this de-wetting effect is avoided and high-quality jetting is possible. The dramatic improvement in jetting quality is likely due to a reduction in surface tension of the meniscus material caused by the addition of a sufficiently high amount of strontium.

Without being bound by theory, in an alternative working mechanism, the highly reactive strontium may preferentially react with the grain boundaries of the alumina nozzle and thus facilitate improved wetting of the meniscus material on the nozzle. Since alumina tends to be reactive along the grain boundaries, likely due to the disrupted crystal structure there, it can be expected that the wetting behavior is controlled (or at least initiated) by the interaction of the molten meniscus material with the grain boundaries.

Strontium may improve the wetting performance by sitting at the grain boundary and blocking interaction between the grain boundary and other constituents of the molten meniscus material. Due to its very stable oxide (thermodynamically more stable than aluminum oxide) and its large size, movement of strontium through the alumina lattice or along the grain boundaries may be restricted and prevent other constituents of the meniscus material alloy to interact with he grain boundaries.

Aluminum-silicon alloys used as meniscus materials for metal drop-on-demand jetting should contain no more than 0.5 wt %, or better no more than 0.1 wt %, or even better no more than 100 ppmw of magnesium to keep nozzle cleaning/maintenance to a minimum. Without frequent nozzle cleaning/maintenance, magnesium concentration higher than these maximum values can result in large variations in droplet characteristics over time which significantly reduces the jet quality.

Without being bound by theory, the origin of this reduction in jetting quality is likely due to the rapid buildup of oxide on the nozzle and/or the meniscus material during jetting. Magnesium is highly reactive, and its oxide is thermodynamically more stable than aluminum oxide. Moreover, magnesium exhibits a relatively high vapor pressure, which at the operating temperature of the system of 600-800 C may result in additional buildup of magnesium oxide on the nozzle. As a result, frequent cleaning of the nozzle is necessary to maintain sufficiently good jetting performance. Nozzle cleaning is time consuming and technically challenging and should be reduced to a minimum to guarantee efficient operation of the printer. This can be achieved by limiting the magnesium concentration in aluminum-silicon feedstock materials to below the maximum levels discussed above.

The magnesium concentration in the aluminum alloys used in casting or welding applications, is highly specified. Magnesium is added as an alloying element to facilitate hardening of the alloy and thus improve its mechanical properties. For the purpose of hardening the alloy, a minimum concentration of Mg is required, and this concentration is often higher than the maximum values allowable for high quality molten metal jetting, as discussed above.

It is highly desirable for Aluminum-silicon alloys used as meniscus materials for metal drop on demand jetting should contain no more than 1000 ppmw, or better no more than 100 ppmw, or even better no more than 10 ppmw of zinc. At zinc concentrations above the specified levels, a large amount of vapor forms and is expelled from the MHD nozzle, especially during jetting. If not otherwise mitigated, this vapor may build up as undesirable deposits on parts of the printer (e.g., the printhead) and the printed parts, and likely presents a health hazard.

Without being bound by theory, the release of vapor likely occurs due to the nature of the MHD jetting process and the high vapor pressure of zinc. Especially during jetting (i.e., ejection of droplets or a stream from the nozzle) a large amount of likely zinc oxide vapor is expelled from the MHD nozzle. Zinc oxide vapors can cause metal fume flu and if not adequately filtered, collected or exhausted, can present a health hazard to the operator of the printer.

Several alternate embodiments of the present disclosure are possible. For instance, a combination of feedstock materials could be used and added to the nozzle to achieve the desired concentration of the key alloying elements. For instance, an off-the-shelf metal alloy could be used as the main feedstock material and separate feedstock materials could be used to increase/decrease the concentration of key alloying elements to within their specified ranges. In order to increase the level of an alloying element, an alloy rich in this element could be added, and vice versa, an alloy poor in this element could be added to decrease the level of the alloying element. Here, the terms “rich” and “poor” are used relative to the concentration of the alloying element in the main feedstock material. This approach is particularly enticing for cases in which a minimum amount of an alloying element is required. Here, the addition of at least the minimum amount of the alloying element would be sufficient to achieve the beneficial effect, independent of the concentration of this element in the main feedstock material.

Instead of decreasing the level of an alloying element in the meniscus material, by adding a feedstock material that is poor in this alloying element, the level of an alloying element may also be reduced by adding a feedstock material that binds with the alloying element in question and renders it inactive with respect to its negative effects on jetting quality.

The multiple feedstock materials may be supplied in the same form or in different forms. For instance, it may be beneficial to supply the main feedstock material in wire or discrete rod form but add small quantities of key alloying elements in powder or granulate form. The key alloying elements may also be applied as a coating on the main feedstock material. Rather than adding the key alloying elements continuously, they may also be added intermittently, as long as the concentration of the key alloying elements in the meniscus material remains higher than the specified minimum for an amount of time sufficient to improve the jetting performance to the desired degree. Moreover, the key alloying element could also be added in non-metallic form. For instance, compounds such as oxides, sulfides, carbides as well as salts and organic compounds of the key alloying elements, could be employed. These compounds may be reduced, decomposed or undergo other chemical reactions that release the key alloying element into the meniscus material.

The concentration of key alloying elements in the meniscus material may also be controlled or augmented through means other than what is typically thought of as a feedstock material. For instance, the jetting nozzle or parts of it, such as for instance the nozzle electrodes, may contain a key alloying element, which is released into the meniscus material, over time. This may be done as the sole means of providing the required alloying element or in conjunction with providing the alloying element as a feedstock component.

Controlling the key alloying elements identified herein has been shown to significantly improve the jetting quality for a range of aluminum alloys, including aluminum silicon alloys with silicon concentration ranging from 5%-12%, such as A356, 4043, 4643, 4047 and 4145.

It is important to note that this disclosure may be implemented by controlling only one, multiple, or all the key alloying elements identified herein. For instance, an improvement in jetting quality may result by controlling only the strontium concentration in the meniscus material, but not controlling the magnesium or zinc concentrations.

Without being bound by theory, controlling the concentration of the elements identified in this disclosure may be applied to jetting metal alloys other than aluminum. For example, controlling the levels of zinc and magnesium may reduce dross build up and vapor formation in various alloys. Controlling the vapor formation can, for instance, ameliorate the same health hazards that occur when welding zinc rich aluminum alloys and that are also present for welding galvanized steels etc.

Without being bound by theory, it may be possible to achieve similar improvements in jetting quality by controlling the concentration of alloying elements other than the ones described above, in the meniscus material.

Without being bound by theory, it is also possible that some of the benefits observed from controlling the amount of key alloying elements in the meniscus material, is specific to the demonstrated nozzle material (i.e. alumina). While a dependence on the nozzle material is possible for the beneficial effect produced by strontium, this is much less likely for the case of magnesium and zinc.

Without being bound by theory, alloying elements other than strontium may also result in similar improvements in jetting quality when they are present in the meniscus material at a sufficiently high level. One category of such alloying elements may include elements with limited solubility in aluminum and low interatomic bonding forces, such as phosphorus, bismuth, antimony, tin and lead. Another category of beneficial alloying elements may include highly reactive elements such as lithium, sodium, potassium, yttrium, chromium, titanium and scandium and especially those which form more stable oxides than aluminum, such as zirconium and calcium. Another category of beneficial alloying elements may include highly reactive elements with large atomic diameter or other characteristics that might limit their grain boundary mobility in alumina, such as for instance gadolinium.

What is claimed is:

1. A method for improving part quality in additive manufacturing, comprising:
supplying a liquid metal aluminum alloy feedstock to an alumina nozzle of an additive manufacturing jetting system;
forming at a face of the alumina nozzle a meniscus of liquid meniscus material, wherein the meniscus material contains greater than or equal to 10 ppmw Strontium such that the Strontium concentration is sufficient to promote wetting of the liquid meniscus on the face of the alumina nozzle; and
jetting a pattern of build material from the alumina nozzle.

2. The method of claim 1 wherein the liquid metal aluminum alloy feedstock includes a plurality of feedstock inputs combined to form the meniscus material.

3. The method of claim 1 wherein the meniscus material contains greater than or equal to 50 ppmw Strontium.

4. The method of claim 1 wherein the meniscus material contains greater than or equal to 100 ppmw Strontium.

5. The method of claim 1 wherein the meniscus wets to an alumina nozzle stem face.

6. The method of claim 1 wherein the alumina nozzle has a non-wetted surface surrounding a discharge orifice.

7. The method of claim 1 wherein at least a portion of a throat material contains greater than or equal to 10 ppmw Strontium.

8. The method of claim 1, further comprising:
wherein the meniscus material contains less than or equal to 0.5 W % Magnesium and less than or equal to 1000 ppmw zinc.

9. A method for improving part quality in additive manufacturing, comprising:
supplying a liquid metal aluminum alloy feedstock to an alumina nozzle an additive manufacturing jetting system;
forming at a face of the alumina nozzle a meniscus of liquid meniscus material wherein the meniscus material contains less than or equal to 0.5 W % Magnesium greater than or equal to 10 ppmw Strontium such that the Strontium concentration is sufficient to promote wetting of the liquid meniscus on the face of the alumina nozzle;
jetting a pattern of build material from the alumina nozzle.

10. The method of claim 9 wherein the metal alloy feedstock includes a plurality of feedstock inputs combined to form the meniscus material.

11. The method of claim 9 wherein the meniscus material contains less than or equal to 0.1 Wt % Magnesium.

12. The method of claim 9 wherein the meniscus material contains less than or equal to 100 ppmw Magnesium.

13. The method of claim 9 wherein the meniscus wets to an alumina nozzle stem face.

14. The method of claim 9 wherein the alumina nozzle has a non-wetted surface surrounding a discharge orifice.

15. A method for improving part quality in additive manufacturing, comprising:
supplying a liquid metal aluminum alloy feedstock to an alumina nozzle an additive manufacturing jetting system;
forming at a face of the alumina nozzle a meniscus of liquid meniscus material wherein the meniscus material contains less than or equal to 1000 ppmw zinc and greater than or equal to 10 ppmw Strontium such that the Strontium concentration is sufficient to promote wetting of the liquid meniscus on the face of the alumina nozzle;
jetting a pattern of build material from the alumina nozzle.

16. The method of claim 15 wherein the metal alloy feedstock includes a plurality of feedstock inputs feeds combined to form the meniscus material.

17. The method of claim 15 wherein the meniscus material contains less than or equal to 100 ppmw Zinc.

18. The method of claim 15 wherein the meniscus wets to an alumina nozzle stem face.

19. The method of claim 15 wherein the alumina nozzle has a non-wetted surface surrounding a discharge orifice.
